(19) United States
(12) Patent Application Publication
(10) Pub. No.: US 2008/0174726 A1
(43) Pub. Date: Jul. 24, 2008

(54) Liquid Crystal Display

(75) Inventor: Jong Seong Kim, Seoul (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/931,909

(22) Filed: Oct. 31, 2007

(30) Foreign Application Priority Data
Jan. 22, 2007 (KR) 10-2007-0006551

(51) Int. Cl. G02F 1/1339; G02F 1/1335

(52) U.S. Cl. 349/106; 349/155; 349/110

(57) ABSTRACT

A liquid crystal display (LCD) includes a first substrate, a pixel electrode formed on the first substrate, a second substrate formed facing the first substrate, a common electrode formed on the second substrate, and a spacer disposed between the first and second substrates. The spacer is circular cylinder shaped or hexahedral-shaped. The spacer may be formed by dissolving a block copolymer that includes a hydrophilic group and a hydrophobic group in an acid aqueous solution including a silica particle precursor or an alkali aqueous solution including a silica particle precursor.

### CROSS-REFERENCE TO RELATED APPLICATION

This application claims priority to and the benefit of Korean Patent Application No. 10-2007-0006551 filed on Jan. 22, 2007, the contents of which are hereby incorporated by reference herein in their entirety.

### BACKGROUND OF THE INVENTION

(a) Technical Field

The present disclosure relates to a liquid crystal display, and more particularly relates to a liquid crystal display having a spacer.

(b) Description of the Related Art

A liquid crystal display (LCD) is one of the most commonly used flat panel displays. The LCD includes two display panels respectively having electrical field generating electrodes formed thereon, and a liquid crystal layer formed between the two display panels. An electrical field may be generated in the liquid crystal layer by applying a voltage to the electrical field generating electrodes so as to determine the direction of liquid crystal molecules of the liquid crystal layer and control the transmittance of light that penetrates the liquid crystal layer.

An upper panel should be maintained at a constant distance from a lower panel of the liquid crystal display, and an active spacer is used to maintain a constant cell gap between the upper and lower panels. The active spacer may include a bead spacer and a column spacer.

As the column spacer is formed by a photolithography process, the column can be fixed to a desired location. However, manufacturing processes for the spacer may become complicated due to the photolithography process.

The bead spacer may be more beneficial than the column spacer in terms of simpler processing and manufacture. However, as the shape of the bead spacer is a sphere, the bead spacer may contact at one point with the upper and lower array panels so that a pressure deviation may be generated during a pressure process of the manufacturing process, thereby generating a cell gap deviation. Further, the sphere shape may increase the mobility of the bead spacer so that the spacers may be concentrated, and therefore an additional process (e.g. heat treatment) may be required to prevent the spacers from being concentrated.

### SUMMARY OF THE INVENTION

Exemplary embodiments of the present invention provide a liquid crystal display (LCD) having a spacer that eliminates a cell gap deviation between upper and lower array panels of the LCD and minimizes the concentration of the spacer. In accordance with an exemplary embodiment of the present invention, a liquid crystal display (LCD) is provided. The LCD includes a first substrate, a pixel electrode, a second substrate, a common electrode, and a spacer. The pixel electrode is formed on the first substrate, the second substrate is formed facing the first substrate, the common electrode is formed on the second substrate, and the spacer is disposed between the first and second substrates. The spacer is circular cylinder-shaped or hexahedral-shaped, and is formed by dissolving a block copolymer that includes a hydrophilic group and a hydrophobic group in an acid aqueous solution including a silica particle precursor or an alkali aqueous solution, including a silica particle precursor.

The silica particle precursor may be provided as tetraethyl orthosilicate.

The block copolymer may include at least one of polyoxyethylene-polyoxypropylene-polyoxyethylene, polyoxyethylene-polyoxypropylene, polyoxypropylene-polyoxyethylene-polyoxypropylene, polystyrene-polyoxyethylene, polystyrene-poly-2-vinylpyridine, polystyrene-poly-4-vinylpyridine, polyethylene-polyoxyethylene, polyethylenepropylene-polyoxyethylene, polymethylmethacrylate-polyoxyethylene, polystyrene-polymethylmethacrylate, polystyrene-polybutadiene, polystyrene-polybutadiene-polystyrene, polystyrene-polyisoprene, polystyrene-polyisoprene-polystyrene, polyN-vinylpyrrolidone-polystyrene, poly(dimethylamino)ethylmethacrylate-methacrylate, poly(2-dimethylamino)ethylmethacrylate-polybutylmethacrylate, polystyrene-poly-2-hyroxyethylmethacrylate, polyisobutyrene-polymethylvinylether, polystyrene-polyhydroxyethylvinylether, polystyrene-polyionicacetylene, polymethyl-3-(methyleneglycol)vinylether-polyisobutylvinylether, poly(2-(1-pyrrolidonyl)ethylvinylether-polyisobutylvinylether), and polylauryllactam-polytetrahydrofuran.

In accordance with an exemplary embodiment of the present invention, a liquid crystal display (LCD) is provided. The LCD includes a thin film transistor (TFT) array panel, a color filter array panel, a liquid crystal, and a spacer. The TFT array panel includes a first substrate, a gate line and a data line formed insulated from each other and crossing each other on the first substrate, a TFT coupled to the gate line and the data line, and a pixel electrode coupled to the TFT. The color filter array panel is formed facing the TFT array panel, and includes a second substrate, a color filter formed on the second substrate, and a common electrode formed on the color filter. The liquid crystal is provided between the TFT array panel and the color filter array panel. The spacer is formed as a circular cylinder or hexahedron shape, and is disposed between the TFT array panel and the color filter array panel.

The silica particle precursor may be provided as tetraethyl orthosilicate.

The block copolymer may include at least one of polyoxyethylene-polyoxypropylene-polyoxyethylene, polyoxyethylene-polyoxypropylene, polyoxypropylene-polyoxyethylene-polyoxypropylene, polystyrene-polyoxyethylene, polystyrene-poly-2-vinylpyridine, polystyrene-poly-4-vinylpyridine, polyethylene-polyoxyethylene, polyethylenepropylene-polyoxyethylene, polymethylmethacrylate-polyoxyethylene, polystyrene-polymethylmethacrylate, polystyrene-polybutadiene, polystyrene-polybutadiene-polystyrene, polystyrene-polyisoprene, polystyrene-polyisoprene-polystyrene, polyN-vinylpyrrolidone-polystyrene, poly(dimethylamino)ethylmethacrylate-methacrylate, poly(2-dimethylamino)ethylmethacrylate-polybutylmethacrylate, polystyrene-poly-2-hyroxyethylmethacrylate, polyisobutyrene-polymethylvinylether, polystyrene-polyhydroxyethylvinylether, polystyrene-polyionicacetylene, polymethyl-3-(methyleneglycol)vinylether-polyisobutylvinylether, poly(2-(1-pyrrolidonyl)ethylvinylether-polyisobutylvinylether), and polylauryllactam-polytetrahydrofuran.

In accordance with another exemplary embodiment of the present invention, a liquid crystal display (LCD) is provided. The LCD includes a first substrate, a pixel electrode formed on the first substrate, a second substrate facing the first substrate and a common electrode formed on the second substrate. The LCD further includes a spacer disposed between the first substrate and the second substrate, with the spacer being circular cylinder-shaped or hexahedral-shaped.

### BRIEF DESCRIPTION OF THE DRAWINGS

Exemplary embodiments of the present invention can be understood in more detail from the following detailed description when taken in conjunction with the attached drawings in which:

FIG. 1 is a layout view of a liquid crystal display (LCD) according to an exemplary embodiment of the present invention.

FIG. 2 is a cross-sectional view of along the line II-II of FIG. 1.

FIG. 3 is a layout view of a display area of a lower display panel in the LCD of FIG. 1.

FIG. 4 is a photo showing a cubic inorganic particle (ZnO) formed by controlling the shape of an inorganic material by using a block copolymer as a templating agent.

FIG. 5 shows a distributed spacer according to an exemplary embodiment of the present invention.

### DETAILED DESCRIPTION OF THE EXEMPLARY EMBODIMENTS OF THE INVENTION

As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. When it is said that any part, such as a layer, film, area, or plate is positioned on another part, it means the part is directly on the other part or above the other part with at least one intermediate part. In contrast, when an element is referred to as being “directly on” another element, there are no intervening elements present.

A thin film transistor (TFT) array panel according to an exemplary embodiment of the present invention will be described in further detail with reference to the accompanying drawings.

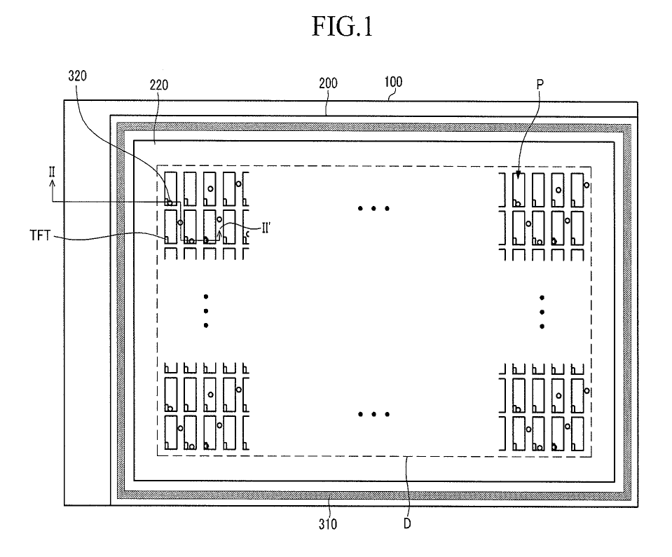

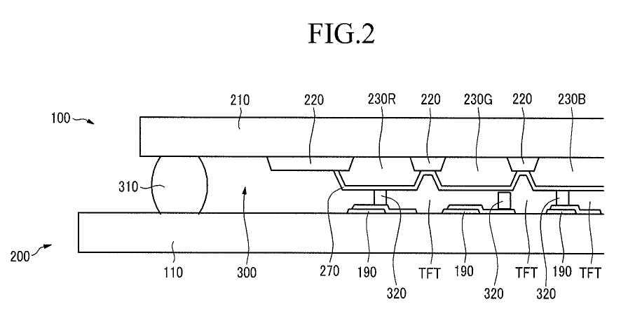

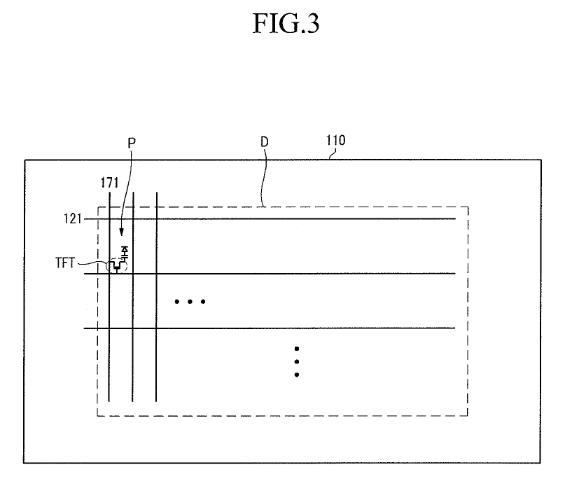

FIG. 1 is a layout view of a liquid crystal display (LCD) according to an exemplary embodiment of the present invention, FIG. 2 is a cross-sectional view along the line II-II of FIG. 1, and FIG. 3 is an enlarged layout view of a display area of a lower array panel of the LCD of FIG. 1.

As shown in FIG. 1 and FIG. 2, a liquid crystal display (LCD) according to an exemplary embodiment of the present invention includes a thin film transistor (TFT) array panel 100, a color filter array panel 200 disposed facing the TFT array panel 100, and a liquid crystal layer 300 filled between the two panels 100 and 200. The liquid crystal layer 300 is sealed by a sealant 310. The two panels 100 and 200 are supported by a distributed spacer 320. The LCD may further includes a compensation film formed outside the respective panels 100 and 200, a polarizer, and a backlight unit disposed at an external front or external side of the TFT array panel 100.

The TFT array panel 100 includes an insulation substrate 110 formed of a transparent insulation material such as, for example, glass, and a plurality of gate lines 121 and data lines 171 are formed in the insulation substrate 110. The gate lines 121 and the data lines 171 are formed crossing but insulated from each other. The gate line 121 transmits a scanning signal and the data line 171 transmits an image signal.

A plurality of pixel areas Ps defined by the respective gate lines 121 and the respective data lines 171 form a display area D on which an image is displayed. One end of the respective gate lines 121 and one end of the respective data lines 171 are extended over the display area D to a peripheral area so as to receive external signals. An area excluding the display area D will be referred to as the peripheral area.

A switch (e.g., a TFT) is formed in the respective pixel areas Ps, and the TFT turns on/off an image signal according to a scan signal.

Each TFT is coupled with a pixel electrode 190 formed of a transparent conductive material (e.g., indium tin oxide (ITO) or indium zinc oxide (IZO)), and the pixel electrode 190 receives an image signal voltage from the corresponding TFT. When the LCD is provided as a reflective LCD, the pixel electrode 190 can be formed of a conductive material with improved reflectivity rather than the transparent material. In this case, the lower polarizer and the lower compensation film are not needed.

On the insulation substrate 210 of the color filter array panel 200, a light blocking member 220, called a black matrix, is formed to prevent light leakage. The light blocking member 220 includes a plurality of openings disposed facing the pixel electrode 190. Each opening is formed with almost the same shape as the pixel electrode 190. The light blocking member 220 may further include an area facing the TFT, and can be extended only along the data line 171.

For example, the light blocking member 220 may be formed of a single layer of chromium, a double layer of chromium and chromium oxide, or an organic layer including a black pigment.

In addition, a plurality of color filters 230R, 230G, and 230B are formed on the insulation substrate 210. The color filters 230R, 230G, and 230B are respectively disposed facing the pixel electrode 190 and formed in a band shape, extending along a vertical direction, and respectively express one of primary colors (e.g. red, green, and blue).

A common electrode 270 formed of a transparent conductive material (e.g., ITO and IZO) is formed below the color filter 230 and the light blocking member 220.

The distributed spacer 320 is disposed between the TFT array panel 100 and the color filter array panel 200. The spacer 320 is disposed in correspondence with the light blocking member 220. In addition, the spacer 320 is formed in, for example, a circular cylinder shape or a hexahedron shape.

To form the circular cylinder-shaped spacer or the hexahedral-shaped spacer, a templating agent is used. An amphoteric block copolymer can be used as the templating agent. One-side block of the amphoteric block copolymer forms a swollen layer, and the other-side block contacts solid particles and forms an anchor. Herein, the block copolymer is a polymer composed of more than two types of monomers arranged in separate partitions.

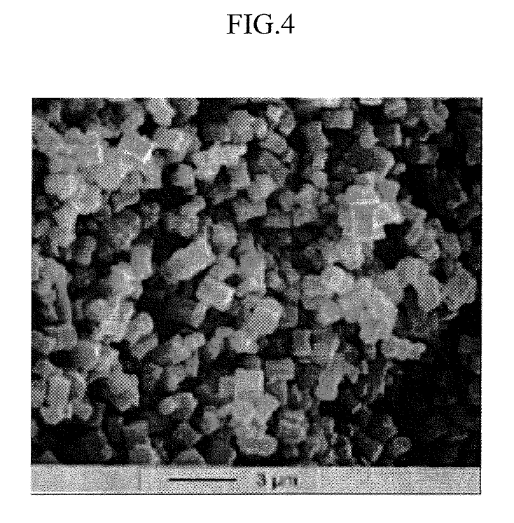

FIG. 4 is a photo showing a cubic inorganic particle (ZnO) formed by controlling the shape of an inorganic material by using a block copolymer as a templating agent.

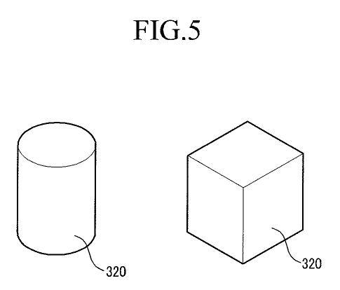

The spacer according to the exemplary embodiment of the present invention is formed of silicon dioxide, and is provided as a distributed spacer in a circular cylinder shape or a hexahedral shape as shown in FIG. 5. Herein, the silicon dioxide is formed by dissolving a block copolymer including a hydrophilic group and a hydrophobic group in an acid aqueous solution or an alkali aqueous solution, including a silica particle precursor such as TEOS.

The block polymer used for manufacturing the spacer for the LCD according to the exemplary embodiment of the present invention may include, for example, at least one of polyoxyethylene-polyoxypropylene-polyoxyethylene, polyoxyethylene-polyoxypropylene, polyoxypropylene-polyoxyethylene-polyoxypropylene, polystyrene-polyoxyethylene, polystyrene-poly-2-vinylpyridine, polystyrene-poly-4-vinylpyridine, polyethylene-polyoxyethylene, polyethylenepropylene-polyoxyethylene, polymethylmethacrylate-polyoxyethylene, polystyrene-polymethylmethacrylate, polystyrene-polybutadiene, polystyrene-polybutadiene-polystyrene, polystyrene-polyisoprene, polystyrene-polyisoprene-polystyrene, polyN-vinylpyrrolidone-polystyrene, poly(dimethylamino)ethylmethacrylate-methacrylate, poly(2-dimethylamino)ethylmethacrylate-polybutylmethacrylate, polystyrene-poly-2-hyroxyethylmethacrylate, polyisobutyrene-polymethylvinylether, polystyrene-polyhydroxyethylvinylether, polystyrene-polyionicacetylene, polymethyl-3-(methyleneglycol)vinylether-polyisobutylvinylether, poly(2-(1-pyrrolidonyl)ethylvinylether-polyisobutylvinylether, and polylauryllactam-polytetrahydrofuran.

As described, when the spacer is formed in the circular cylinder or hexahedron shape, a contact area of the lower substrate may be increased so that a pressure deviation of a pressure process during a manufacturing process can be reduced, thereby reducing a cell gap deviation. In addition, concentration of the spacer is minimized, and accordingly difficulties due to the concentration of the spacer may be reduced.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A liquid crystal display (LCD) comprising:
a first substrate,
a pixel electrode formed on the first substrate;
a second substrate facing the first substrate;
a common electrode formed on the second substrate; and
a spacer disposed between the first substrate and the second substrate,
wherein the spacer is circular cylinder-shaped or hexahedral-shaped and is formed by dissolving a block copolymer that includes a hydrophilic group and a hydrophobic group in an acid aqueous solution including a silica particle precursor or an alkali aqueous solution including a silica particle precursor.

2. The LCD of claim 1, wherein the silica particle precursor is tetraethyl orthosilicate.

3. The LCD of claim 1, wherein the block copolymer comprises at least one of polyoxyethylene-polyoxypropylene-polyoxyethylene, polyoxyethylene-polyoxypropylene, polyoxypropylene-polyoxyethylene-polyoxypropylene, polystyrene-polyoxyethylene, polystyrene-poly-2-vinylpyridine, polystyrene-poly-4-vinylpyridine, polyethylene-polyoxyethylene, polyethylenepropylene-polyoxyethylene, polymethylmethacrylate-polyoxyethylene, polystyrene-polymethylmethacrylate, polystyrene-polybutadiene, polystyrene-polybutadiene-polystyrene, polystyrene-polyisoprene, polystyrene-polyisoprene-polystyrene, polyN-vinylpyrrolidone-polystyrene, poly(dimethylamino)ethylmethacrylate-methacrylate, poly(2-dimethylamino)ethylmethacrylate-polybutylmethacrylate, polystyrene-poly-2-hyroxyethylmethacrylate, polyisobutyrene-polymethylvinylether, polystyrene-polyhydroxyethylvinylether, polystyrene-polyionicacetylene, polymethyl-3-(methyleneglycol)vinylether-polyisobutylvinylether, poly(2-(1-pyrrolidonyl)ethylvinylether-polyisobutylvinylether), and polylauryllactam-polytetrahydrofuran.

4. A liquid crystal display (LCD) comprising:
a thin film transistor (TFT) array panel including a first substrate, a gate line and a data line formed insulated from each other and crossing each other on the first substrate, a TFT coupled to the gate line and the data line, and a pixel electrode coupled to the TFT;
a color filter array panel formed facing the TFT array panel, and including a second substrate, a color filter formed on the second substrate, and a common electrode formed on the color filter;
a liquid crystal provided between the TFT array panel and the color filter array panel; and
a spacer formed in a circular cylinder or hexahedron shape, and the spacer being disposed between the TFT array panel and the color filter array panel,
wherein the spacer is formed by dissolving a block copolymer that includes a hydrophilic group and a hydrophobic group in an acid aqueous solution including a silica particle precursor or an alkali aqueous solution including a silica particle precursor.

5. The LCD of claim 4, wherein the silica particle precursor is tetraethyl orthosilicate.

6. The LCD of claim 4, wherein the block copolymer comprises at least one of polyoxyethylene-polyoxypropylene-polyoxyethylene, polyoxyethylene-polyoxypropylene, polyoxypropylene-polyoxyethylene-polyoxypropylene, polystyrene-polyoxyethylene, polystyrene-poly-2-vinylpyridine, polystyrene-poly-4-vinylpyridine, polyethylene-polyoxyethylene, polyethylenepropylene-polyoxyethylene, polymethylmethacrylate-polyoxyethylene, polystyrene-polymethylmethacrylate, polystyrene-polybutadiene, polystyrene-polybutadiene-polystyrene, polystyrene-polyisoprene, polystyrene-polyisoprene-polystyrene, polyN-vinylpyrrolidone-polystyrene, poly(dimethylamino)ethylmethacrylate-methacrylate, poly(2-dimethylamino)ethylmethacrylate-polybutylmethacrylate, polystyrene-poly-2-hyroxyethylmethacrylate, polyisobutyrene-polymethylvinylether, polystyrene-polyhydroxyethylvinylether, polystyrene-polyionicacetylene, polymethyl-3-(methyleneglycol)vinylether-polyisobutylvinylether, poly(2-(1-pyrrolidonyl)ethylvinylether-polyisobutylvinylether), and polylauryllactam-polytetrahydrofuran.

7. The LCD of claim 4, further comprising a light blocking member disposed on the second substrate of the color filter array panel.

8. The LCD of claim 7, wherein the light blocking member includes a plurality of openings disposed facing the pixel electrode.

9. The LCD of claim 8, wherein each opening is formed with substantially the same shape as the pixel electrode.

10. The LCD of claim 7, wherein the light blocking member is formed of a single layer of chromium.

11. The LCD of claim 7, wherein the light blocking member is formed of a double layer of chromium and chromium oxide.

12. The LCD of claim 7, wherein the light blocking member is formed of an organic layer which includes a black pigment.

13. The LCD of claim 4, wherein the color filter includes a plurality of color filters disposed facing the pixel electrode and formed in a band shape, extending along a vertical direction.

14. A liquid crystal display (LCD) comprising:
a first substrate,
a pixel electrode formed on the first substrate;
a second substrate facing the first substrate;
a common electrode formed on the second substrate; and
a spacer disposed between the first substrate and the second substrate,
wherein the spacer is circular cylinder-shaped or hexahedral-shaped.
